(19) United States
(12) Patent Application Publication
(10) Pub. No.: US 2001/0032885 A1
(43) Pub. Date: Oct. 25, 2001

(54) CHIP CARD WITH PERSONALIZATION MEMORY, AND A PROCESS FOR THE INPUT AND OUTPUT OF DATA

(76) Inventor: KLAUS-ERWIN GROEGER, DIEKHOLZEN (DE)

Correspondence Address: KENYON & KENYON, ONE BROADWAY, NEW YORK, NY, 10004, US

(21) Appl. No.: 09/242,853

(22) PCT Filed: Jul. 14, 1997
(86) PCT No.: PCT/DE97/01478

§ 371 Date: None

(30) Foreign Application Priority Data
Aug. 23, 1996 (DE) 1 96 34 064.0

(51) Int. Cl. G06K 19/06; G06K 19/00

(52) U.S. Cl. 235/492

(57) ABSTRACT

A chip card which has an additional memory with personalization data is proposed. The data in the additional memory are read out and written in a manner which bypasses the operating system of the microprocessor.

The present invention is based on a chip card having a memory, and on a method for inputting and outputting data, according to the species defined in the independent claims.

Chip cards are being used to an increasing extent. A chip card is usually a plastic card into which a microchip is embedded. For many applications, a chip card of standardized size is provided. Essentially two types of cards are known, namely memory chip cards and processor chip cards. The memory chip card is equipped at least with a memory chip, and the processor chip card additionally contains a processor chip. A chip card of this kind is known from the article “Rechengenie in der Plastikkarte”, T. Wille, Funkschau 7/1993. An intelligent memory chip card is provided here, security functions being implemented by the integrated processor. The memory cards can be completely or partially read out with a knowledge of their bus format. Cards with an upstream controller can be read with a knowledge of the operating system and special algorithms. In order to differentiate among the large number of cards, they are made often made identifiable by the issuers by imprinting. The fact that a card belongs to a person is documented by printing on or embossing his or her name, or by reproducing a photo. There also exist a plurality of cards which have no “personalization,” and thus are entirely anonymous. If such a card is lost, it can often be associated with its owner only by the issuer and with major technical outlay, since the card cannot easily be read out.

### SUMMARY OF THE INVENTION

The chip card according to the present invention having the characterizing features of the independent claim has, in contrast, the advantage that it possesses, in addition to the memories present in the known chip cards, a memory region in which exclusively data for identification of the user are stored. The data which are protected via the security standard of the card are therefore separated from the data which are to be publicly accessible and which contain the personalization. Printing or embossing of the card is also dispensed with.

The features set forth in the dependent claims make possible an advantageous development of and improvement to the chip card indicated in the independent claim.

It is particularly advantageous if the additional memory region is a part of the memory that is already present on the card. This part of the memory must, however, be identified as a separate memory region, since it is not intended to be subject to the control function of the microprocessor. It is furthermore advantageous to install the memory on the card as a separate component.

The method according to the present invention for reading data in and out, as defined by the characterizing features of the independent claim, has the advantage that the data which were stored in additional memories can be read in and output in a manner which bypasses the operating system of the microprocessor. It is thus easily possible to write onto the card, via an external terminal, those data which the user himself or herself would like to make public.

### BRIEF DESCRIPTION OF THE DRAWING

An exemplary embodiment of the invention is depicted in the drawing and explained in more detail in the description below.

FIG. 1 schematically shows the layout of a chip card according to the present invention.

### DETAILED DESCRIPTION

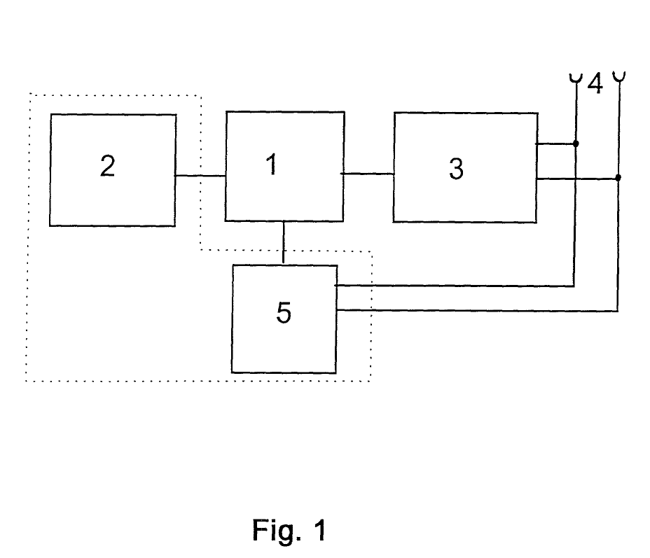

FIG. 1 schematically depicts a chip card whose core is a microprocessor 1. This microprocessor is connected to a memory unit 2 in which programs and data are stored. By way of an input/output unit 3, information is output from memory 2 to contacts 4 or received therefrom. An additional memory 5, in which personalized data can be stored, is integrated into the chip card according to the present invention as an additional component. This memory 5 is not covered by the usual security standard of the card. It is a special, freely accessible memory region that does not need to be addressed with special keys via a data bus or an operating system. This special memory 5 can be embodied physically as an additional memory module, or can be accessible, bypassing the operating system, as a subregion of program and data memory 2. Each user decides himself or herself which data are stored in additional memory 5. The user can input personal data, but also a blood group indication, a desire to be designated as an organ donor, or information about medical conditions or persons to be notified. The personalization data are input via simple terminals which do not need to have anything to do with the actual function of the chip card. The chip card itself contains externally no further indication as to the owner. If such a card is lost, the finder can read out the personalization data at any time using a simple terminal, so that the card can easily be returned.

1. A chip card comprising a microprocessor (1), located on the card, and a memory (2) connected thereto for programs and/or data, as well as an input/output unit (3) which delivers and receives information to and from terminal contacts (4), wherein the chip card contains an additional memory (5), editable by anyone, having data to identify the owner.

2. The chip card as defined in claim 1, wherein the additional memory (5) is physically a part of the memory module (2).

3. The chip card as defined in claim 1, wherein the additional memory (5) is a separate component.

4. A method for reading out and reading in data that are stored on a chip card having a microprocessor (1) and a memory (2) for programs and data as well as an input/output unit (3), wherein the additional memory (5) can be read from or written to in a manner which bypasses the operating system of the microprocessor.

5. The method for reading in and reading out data as defined in claim 4, wherein the data of the additional memory (5) can be read and written via an input/output device.
